(19) United States
(12) Patent Application Publication
(10) Pub. No.: US 2015/0162142 A1
(43) Pub. Date: Jun. 11, 2015

(54) WIRE FOR REED SWITCH, REED FOR REED SWITCH, AND REED SWITCH

(71) Applicant: SUMITOMO ELECTRIC INDUSTRIES, LTD., Osaka-shi (JP)

(72) Inventors: Hajime Ota, Osaka-shi (JP); Taichiro Nishikawa, Osaka-shi (JP); Kazuo Yamazaki, Neyagawa-shi (JP); Takeshi Tokuda, Neyagawa-shi (JP); Norimasa Kawano, Neyagawa-shi (JP)

(21) Appl. No.: 14/413,479

(22) PCT Filed: Jul. 9, 2013
(86) PCT No.: PCT/JP2013/068699

§ 371 Date: Jan. 8, 2015

(30) Foreign Application Priority Data
Jul. 10, 2012 (JP) 2012-154758

(51) Int. Cl. H01H 1/02; H01H 51/28; C22C 19/07; H01H 36/00

(52) U.S. Cl. CPC H01H 1/0201; H01H 36/0006; H01H 51/282; C22C 19/07

(57) ABSTRACT

A reed switch 10 includes a cylindrical glass tube 30 and a plurality of reeds 20 fixed to the glass tube 30 in a state where an end side including a contact point portion 22 of each of the reeds 20 is inserted in the glass tube 30. The reeds 20 are each produced by forming, by plastic working, a contact point portion 22 on an end side of a wire for a reed switch. The wire for a reed switch is composed of an iron-group alloy containing, by percent by mass, 1% or more and 10% or less of Fe, 10% or more and 35% or less of Ni, and the balance being Co and impurities and having a cubic crystal structure. The wire has a Curie temperature of 900° C. or higher and a wire diameter of 1 mm or less. The wire is composed of a ternary alloy having a particular composition. Therefore, the wire has a high Curie temperature, a low resistance, and a particular structure and thus has good workability.

### TECHNICAL FIELD

The present invention relates to a wire for a reed switch, the wire being suitable for a material of a reed included in a reed switch, a reed for a reed switch, and a reed switch. In particular, the present invention relates to a wire for a reed switch, the wire having a high Curie temperature, a low resistance, and good workability.

### BACKGROUND ART

Reed switches that combine a magnet such as a permanent magnet and an electric magnet with reeds composed of a magnetic material such as ion or an iron alloy are used in a switching component such as a relay and various sensor components. A reed switch includes a cylindrical glass tube filled with a sealing gas or the like and a pair of reeds, in which an end side of a reed is inserted in each end of the glass tube. The reeds are fixed to the glass tube such that ends of the reeds overlap with each other when viewed in a longitudinal direction of the glass tube and separate from each other when viewed in the radial direction of the glass tube. The ends of the two reeds arranged with a gap therebetween as described above are operated by a magnet arranged outside the glass tube so as to be in non-contact (open) or contact (close) with each other, and used as a contact point.

A typical material of reeds is a Fe-50 mass % to 52 mass % Ni alloy (PTL 1). PTL 2 has proposed a Fe-15% to 59% Co-1% to 40% Ni alloy (weight ratio) (Fe: about 30% to 40%) which has a high magnetic flux density and good workability as compared with a Fe-52 mass % Ni alloy.

### CITATION LIST

### Patent Literature

PTL 1: Japanese Unexamined Patent Application Publication No. 05-320842

PTL 2: Japanese Unexamined Patent Application Publication No. 03-179622

### SUMMARY OF INVENTION

### Technical Problem

However, the reed switches in the related art are not suitable for use in which a large current, for example, 3 A or more, or furthermore 5 A or more is supplied.

The Fe-52 mass % Ni alloy has a high specific resistance. Therefore, when a large current is allowed to flow to the alloy, the temperature of the alloy is increased by the Joule heat and becomes high. In addition, since the Fe-52 mass % Ni alloy has a low Curie temperature, magnetic properties are degraded with an increase in the temperature. Therefore, when reeds composed of the Fe-52 mass % Ni alloy are used in a large-current application, the open-close operation may not be appropriately performed due to the degradation of the magnetic properties.

Furthermore, electric properties and a thermal expansion coefficient of the Fe-52 mass % Ni alloy may be changed with an increase in the temperature. In general, the specific resistance and the thermal expansion coefficient are increased at high temperatures. For example, when the thermal expansion coefficient increases, the amount of thermal expansion and contraction also increases. Consequently, a strain is applied to a joined portion between a reed and a glass tube, the adhesion between the reed and the glass tube is broken with time. For example, a gap may be formed between the reed and the glass tube, and the sealing gas in the glass tube may leak. Alternatively, when the open-close operation of the reed switch is repeatedly performed, the reed may be finally detached from the glass tube.

A reed for a reed switch is produced by cutting a long wire to have a particular length to prepare a rod, and forming the rod into a desired shape by conducting plastic working such as press working on one end side (the side functioning as a contact point) of the rod. Therefore, the material for a reed desirably has good workability. Although the alloy described in PTL 2 has good workability, the alloy has a high content of Fe and a low Curie temperature, and is inferior in terms of magnetic properties.

As described above, it is desirable that a material of a reed for a reed switch particularly used for a large current have a high Curie temperature, a low resistance, and good workability.

Accordingly, an object of the present invention is to provide a wire for a reed switch, the wire having a high Curie temperature, a low resistance, and good workability. Another object of the present invention is to provide a reed for a reed switch, the reed having a high Curie temperature and a low resistance. Still another object of the present invention is to provide a reed switch suitable for use in a large current.

### Solution to Problem

In the present invention, the above objects are achieved by using a ternary alloy of Co, Fe, and Ni, the alloy having a particular composition and a particular structure.

A wire for a reed switch of the present invention is used as a material of a reed included in a reed switch, and is composed of an iron-group alloy containing, by percent by mass, 1% or more and 10% or less of Fe, 10% or more and 35% or less of Ni, and the balance being Co and impurities. The iron-group alloy has a cubic crystal structure. The wire has a Curie temperature of 900° C. or higher and a wire diameter of 1 mm or less.

The wire for a reed switch of the present invention is composed of an iron-group alloy having a particular composition as described above, in particular, an alloy having a low Fe content (Fe: 10% by mass or less) and a high Co content (Co: 55% by mass or more), and has good magnetic properties. Specifically, the Curie temperature is high, namely, 900° C. or higher. In addition, since the wire is composed of an iron-group alloy having the particular composition, the specific resistance is also low. Accordingly, even when a large current is supplied to the wire for a reed switch of the present invention, not only the temperature of the wire does not easily increase but also degradation of magnetic properties caused by an increase in the temperature can be suppressed because the Curie temperature is high as described above. Furthermore, since the wire for a reed switch of the present invention has a cubic crystal structure (₇-structure), the wire has a good plastic working property. Accordingly, various types of plastic working such as wiredrawing for producing a thin wire having a diameter of 1 mm or less and press working for forming into a desired shape can be satisfactorily performed. In addition, since the wire for a reed switch of the present invention has a small wire diameter, the wire can provide reeds for a small reed switch and contribute to a reduction in the size of the reed switch.

According to an embodiment of the present invention, the wire may be composed of an iron-group alloy containing, by percent by mass, 3% or more and 5% or less of Fe, 20% or more and 30% or less of Ni, and the balance being Co and impurities.

In the above embodiment, since the wire contains Co, which has a high Curie temperature, in a higher content (Co: 65% by mass or more), the Curie temperature of the wire is higher (for example, 1,000° C. or higher).

According to an embodiment of the present invention, a specific resistance at room temperature may be 15 μΩ·cm or less.

In the above embodiment, the specific resistance (electrical resistivity) is sufficiently low. Even when a large current is supplied, the temperature of the wire is not easily increased by the Joule heat, and does not easily become high. Accordingly, in the above embodiment, degradation of properties (such as decreases in magnetic properties and electric properties and an increase in the thermal expansion coefficient) due to an increase in the temperature can be further suppressed.

By appropriately performing plastic working on the wire for a reed switch of the present invention, a reed for a reed switch is obtained. The reed for a reed switch of the present invention is produced from the wire for a reed switch of the present invention and includes, on an end side thereof, a contact point portion formed by plastic working.

The reed for a reed switch of the present invention produced by performing plastic working on the wire for a reed switch of the present invention, the wire having a high Curie temperature and a low resistance as described above, substantially maintains the composition of the wire for a reed switch of the present invention. Thus, the reed also has a high Curie temperature and a low resistance. In addition, the wire for a reed switch of the present invention, the wire having a good plastic working property, can be satisfactorily subjected to plastic working even in the case where the wire is formed into a complex shape, and a reed having a desired shape can be obtained. Thus, the reed for a reed switch of the present invention is also good in terms of productivity.

By attaching the reeds for a reed switch of the present invention to a glass tube, a reed switch is obtained. The reed switch of the present invention includes a cylindrical glass tube and a plurality of reeds fixed to the glass tube in a state where an end side including a contact point portion of each of the reeds is inserted in the glass tube, in which the reeds are each the reed for a reed switch of the present invention.

The reed switch of the present invention includes the reeds for a reed switch of the present invention, the reeds having a high Curie temperature and a low resistance as described above. Accordingly, even when a large current is supplied to the reed switch of the present invention, the temperature of the reed switch does not easily increase, and degradation of properties (such as decreases in magnetic properties and electric properties and an increase in the thermal expansion coefficient) due to an increase in the temperature can be suppressed. Accordingly, the reed switch of the present invention can be suitably used in component members such as a switch component and a sensor component not only for low-current applications (the value of current supplied: 1 A or less), but also for large-current applications.

### Advantageous Effects of Invention

The wire for a reed switch of the present invention has a high Curie temperature, a low resistance, and good workability. The reed for a reed switch of the present invention and the reed switch of the present invention have high Curie temperatures and low resistances.

### BRIEF DESCRIPTION OF DRAWINGS

FIG. 1A is a schematic explanatory view of a reed switch and shows an open state.

FIG. 1B is a schematic explanatory view of a reed switch and shows a closed state.

Reference Signs List

10 reed switch 20 reed 21 fixed portion 22 contact point portion
30 glass tube

### DESCRIPTION OF EMBODIMENTS

Embodiments of the present invention will now be described in more detail. In compositions, the content of an element is represented by a mass ratio (% by mass).

[Wire for Reed Switch]

(Composition)

An iron-group alloy contained in a wire for a reed switch of the present invention is a ternary alloy containing three elements of iron (Fe), nickel (Ni), and cobalt (Co) as main components (essential elements) and has a highest content of Co and a lowest content of Fe. Specifically, the wire for a reed switch of the present invention is composed of an iron-group alloy containing 1% or more and 10% or less of Fe, 10% or more and 35% or less of Ni, and the balance being Co and impurities.

The wire for a reed switch of the present invention contains 1% of more of Fe and 10% or more of Ni. Accordingly, in a ternary phase diagram (not shown), a region of a cubic crystal structure (₇-structure) having a good plastic working property is large, and it is easy to obtain a composition having good workability of various types of plastic working, such as wiredrawing and press working. The higher the content of each of Fe and Ni, the more easily a cubic crystal structure is formed, and the higher the workability. However, when the Fe content and the Ni content are excessively high, both corrosion resistance and oxidation resistance decrease and the specific resistance increases. Therefore, the Fe content is 10% or less and the Ni content is 35% or less.

In the wire for a reed switch of the present invention, except for impurities, the balance of the iron-group alloy is Co, which has a high Curie temperature, and thus the iron-group alloy has a high Curie temperature. The higher the content of Co, the higher the Curie temperature of the iron-group alloy. The content of Co is preferably 60% or more, more preferably 65% or more, and particularly preferably 70% or more. However, cobalt has a hexagonal crystal structure, which has a poor plastic working property. Accordingly, when the content of Co is excessively high, workability decreases. The content of Co is preferably 80% or less.

In particular, when the iron-group alloy of the wire for a reed switch of the present invention contains 3% or more and 5% or less of Fe, 20% or more and 30% or less of Ni, and the balance being Co and impurities, the content of Co is higher (65% or more) and thus a wire having a higher Curie temperature can be provided. Specifically, a Curie temperature of 950° C. or higher, and furthermore, 1,000° C. or higher can be satisfied.

In an embodiment, the impurities in the iron-group alloy may be composed of only elements (inevitable impurities) that are not intentionally added in a production process. An example of the inevitable impurities is carbon (C). When the content of C is high, workability decreases. The content of C is preferably 0.01% or less. Alternatively, the impurities in the iron-group alloy may contain, in addition to the inevitable impurities, elements (hereinafter referred to as “additional elements”) that are intentionally added for the purpose of deoxidation or the like. Examples of the additional elements include Cr, Mn, Si, Al, and Ti. Chromium (Cr), manganese (Mn), silicon (Si), aluminum (Al), and titanium (Ti) function as a deoxidizing agent. However, high contents of these elements cause an increase in the electrical resistance and a decrease in magnetic properties, resulting in a decrease in properties of the reed switch. Accordingly, the total content of Cr, Mn, Si, Al, and Ti is preferably 0.9% or less. The content of the additional elements can be reduced by conducting refining or the like at the time of melting. The total content of the impurities in the iron-group alloy is preferably 1% or less.

(Structure)

A feature of the iron-group alloy contained in the wire for a reed switch of the present invention is that the iron-group alloy has a cubic crystal structure. Since the iron-group alloy has a cubic crystal structure, the alloy has a good plastic working property, and various types of plastic working such as wiredrawing for producing a thin wire having a wire diameter of 1 mm or less and press working for forming a complicated shape can be satisfactorily performed. The cubic crystal structure mainly depends on the Fe content, the Ni content, and the Co content. Accordingly, the Fe content, the Ni content, and the Co content are selected in the above specific content ranges such that the iron-group alloy has the cubic crystal structure (γ-structure).

(Magnetic Property)

A feature of the wire for a reed switch of the present invention is that the wire has a high Curie temperature. Specifically, the Curie temperature is 900° C. or higher. With an increase in the Curie temperature, degradation of magnetic properties due to an increase in the temperature less likely occurs. The upper limit of the Curie temperature is not particularly determined. The Curie temperature mainly depends on the composition. The higher the content of Co, the more easily the Curie temperature becomes high. In an embodiment, for example, the Curie temperature may be 950° C. or higher, 970° C. or higher, 1,000° C. or higher, 1,010° C. or higher, or 1,020° C. or higher.

(Electric Property)

The wire for a reed switch of the present invention, the wire being composed of an iron-group alloy having a particular composition, has a low resistance and a low specific resistance. In an embodiment, for example, the specific resistance at room temperature may be 15 μΩ·cm or less. The specific resistance mainly depends on the composition. The higher the Fe content and the Ni content, the more easily the specific resistance becomes high. The higher the content of Co, the more easily the specific resistance becomes low. The lower the specific resistance, the more significantly the generation of heat due to the Joule heat can be suppressed and the more significantly an increase in the temperature can be suppressed even in the case where a large current is supplied. The specific resistance at room temperature is preferably 14 μΩ·cm or less, more preferably 13 μΩ·cm or less, and particularly preferably 10 μΩ·cm or less.

(Shape)

A typical example of the wire for a reed switch of the present invention is a round wire whose cross section has a circular shape. Other examples of the wire for a reed switch include rectangular wires whose cross section has a polygonal shape such as a rectangular shape, and deformed wires whose cross section has a deformed shape such as an elliptical shape.

(Size)

A feature of the wire for a reed switch of the present invention is that the wire diameter (in the case of a rectangular wire or a deformed wire, the diameter of the envelope circle) is 1 mm or less. The wire diameter can be appropriately selected in accordance with the design value of a reed. The wire diameter may be, for example, 0.2 to 0.8 mm. The degree of wiredrawing may be selected so as to obtain a desired wire diameter. Since the wire for a reed switch of the present invention has such a small diameter, a small reed can be produced, and furthermore, a small reed switch can be produced.

The length of the wire for a reed switch of the present invention is not particularly limited. A typical embodiment of a long wire is a wire that is wound in the form of a coil. Alternatively, the wire may be a wire having a short length, the wire being produced by cutting a wire to have a predetermined length (for example, a designed length of a reed).

(Method for Producing Wire for Reed Switch)

A wire for a reed switch of the present invention is typically obtained by melting→casting→hot working (forging and rolling)→cold wiredrawing→heat treatment. In particular, an alloy molten metal whose components are adjusted may be prepared in vacuum. Subsequently, the molten metal may be refined to remove or decrease impurities and inclusions, and the temperature may be adjusted. This method is preferable from the viewpoint that the amounts of impurities and inclusions can be reduced. Such an alloy molten metal is subjected to casting such as vacuum casting to prepare an ingot. The ingot is then subjected to hot working to prepare a worked material. The worked material is repeatedly subjected to cold wiredrawing and heat treatment. Thus, a wire having a small diameter is obtained. By performing a softening treatment on the wire having a final wire diameter, a wire having good toughness such as elongation, that is, a wire having good workability is obtained.

[Reed for Reed Switch]A reed for a reed switch of the present invention is a linear body, at least one end side of the reed is subjected to plastic working, and a contact point portion is provided on the one end side. The shape of the contact point portion is not particularly limited. For example, the contact point portion may have a shape having a planar region so as to have a sufficient contact area. In an embodiment, another end side of the reed is not subjected to plastic working, and the specifications (such as the composition, structure, shape, size, etc.) of the wire for a reed switch of the present invention, the wire being used as a material, are substantially maintained. Note that the composition and the structure of the iron-group alloy constituting the region that has been subjected to plastic working are substantially the same as those of the wire for a reed switch of the present invention, the wire being used as the material.

The reed for a reed switch of the present invention can be produced by performing plastic working such as press working on at least one end side of the wire for a reed switch of the present invention, the wire having a predetermined length (designed length), to form a contact point portion having a desired shape.

[Reed Switch]

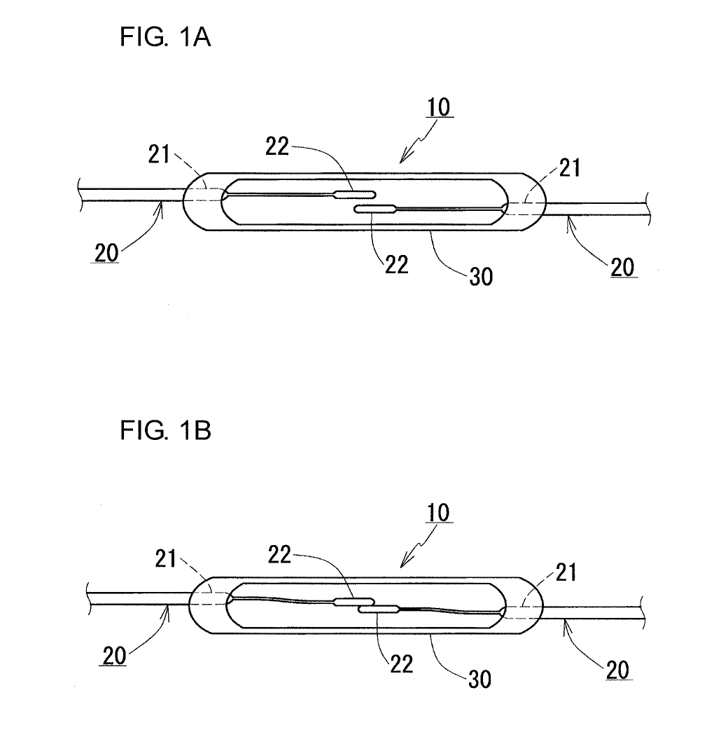

A reed switch of the present invention will be described with reference to FIGS. 1A and 1B. A reed switch 10 has a basic structure the same as that of a known reed switch. The reed switch 10 includes at least two reeds 20 and a cylindrical glass tube 30 in which the reeds 20 are fixed in a state where an end side of each of the reeds 20 is inserted. In each of the reeds 20, one end side region including a contact point portion 22 is inserted in the glass tube 30, a middle region functions as a fixed portion 21 that is fixed to the glass tube 30, and another end side region is exposed from the glass tube 30. In the reeds 20, the contact point portions 22 on the one end side inserted in the glass tube 30 are typically arranged so as to overlap with each other in the longitudinal direction of the glass tube 30 and separate from each other in the radial direction of the glass tube 30 (open state), as shown in FIG. 1A. When a magnetic suction force by a magnet (not shown) arranged outside the glass tube 30 acts on the reed switch 10, the contact point portions 22 come in contact with each other (closed state), as shown in FIG. 1B. When the magnetic suction force is removed, the contact point portions 22 are returned to the non-contact state by the elasticity of the reeds 20, as shown in FIG. 1A.

In a typical embodiment, as shown in FIG. 1A, one reed 20 is fixed to each end of the cylindrical glass tube 30. That is, a reed switch includes a pair of reeds 20. In another embodiment, two reeds 20 may be fixed to an end of the cylindrical glass tube 30 with a distance therebetween, and one reed 20 may be fixed to another end of the glass tube 3. In this embodiment, one end side region of the one reed 20 may be arranged so as to be inserted between end side regions of the two reeds 20. That is, a reed switch includes three reeds.

A glass tube composed of a glass having a thermal expansion coefficient (for example, 120×10⁻⁷/° C. to 130×10⁻⁷/° C. (12 to 13 ppm/K)) which is close to the thermal expansion coefficient of the reeds can be used as the glass tube. The atmosphere in the glass tube may be an inert atmosphere filled with an inert gas such as nitrogen gas, an atmosphere having a low content of oxygen, such as vacuum, or an atmosphere that does not substantially contain oxygen. Since the one end side region of each of the reeds functioning as a contact point is inserted in the glass tube, the contact point portions can be mechanically protected. Since the atmosphere in the glass tube is the atmosphere described above, corrosion in the contact point portions due to outside air, moisture, and the like can be prevented.

The reed switch can be basically produced by a known production method. Typically, the reed switch is produced as follows. An end of a glass tube is heated in a state where a reed is inserted and arranged in the end of the glass tube. Thus, the reed is fixed to the glass tube. Another end of the glass tube is then heated in a state where another reed is inserted and arranged in the other end of the glass tube having a desired atmosphere. Thus, the other reed is fixed to the glass tube, and the glass tube is sealed. Before the reeds are fixed to the glass tube, an oxide film may be formed on portions of the reeds that are to come in contact with the glass. In this case, high bondability between the glass tube and each of the reeds can be obtained. In an embodiment, a platinum-group layer composed of rhodium (Rh), ruthenium (Ru), or the like may be provided on a surface of the contact point portions of the reeds. In this case, the contact resistance can be reduced. The platinum-group layer can be formed by plating, welding, or the like.

### Test Example 1

Alloy wires containing Fe were prepared. Magnetic properties, electric properties, and heat properties of the alloy wires were examined.

The alloy wires were each prepared through the steps of melting→casting→surface cutting→hot forging→hot rolling→cold wiredrawing→heat treatment. More specifically, first, a molten metal (Sample No. I) of a Co—Ni—Fe alloy was prepared by using a common vacuum melting furnace such that the Co content, the Fe content, and the Ni content were the contents (unit: % by mass) shown in Table I. A molten metal (Sample No. 100) of a Fe—Ni alloy was prepared such that the Fe content and the Ni content were the contents shown in Table I.

In order to decrease or remove impurities and the like, refining of each of the molten metals was performed. The temperature of the prepared molten metal was appropriately adjusted, and an ingot was obtained by vacuum casting. The surface of the ingot was cut to remove an oxide layer and the like. Hot forging and hot rolling were then sequentially performed. Thus, a rolled wire having a wire diameter φ of 5.5 mm was obtained. Cold wiredrawing and heat treatment were performed on the rolled wire in combination. Thus, a wire having a wire diameter φ (diameter) of 0.6 mm was obtained. The composition of the wire of Sample No. 1 was examined by inductively coupled plasma (ICP) optical emission spectrometry. The Co content, the Fe content, and the Ni content in the wire were respectively substantially the same as the Co content, the Fe content, and the Ni content used as the materials. The elements shown in Table I were detected as impurities. The analysis of the composition may be performed by atomic absorption spectrophotometry or the like instead of ICP optical emission spectrometry.

TABLE I

| Sam- | | | | | | | | | |
|---|---|---|---|---|---|---|---|---|---|
| ple | Composition (% by mass) | | | | | | | | |
| No. | Co | Ni | Fe | C | Cr | Mn | Si | Al | Ti |
| 1 | Bal- | 25 | 4 | 0.005 | 0.006 | 0.001 | 0.001 | 0.005 | 0.0001 |
| | ance | | | | | | | | |
| 100 | 0.03 | 52 | Bal- | 0.001 | 0.01 | 0.24 | 0.06 | 0.0001 | 0.0001 |
| | | | ance | | | | | | |

The structure of the wire of Sample No. 1 was examined by performing crystal structure analysis by X-ray diffraction. According to the results, the wire of Sample No. 1 had a cubic crystal structure.

Regarding each of the wires of Sample Nos. 1 and 100, a Curie temperature (° C.) was measured as a magnetic property, a specific resistance (μΩ·cm) was measured as an electric property, and a thermal expansion coefficient (ppm/K) was measured as a heat property. The results are shown in Table II.

The Curie temperature was measured with a commercially available calorimeter. The specific resistance was measured at room temperature (about 20° C. in this test) by a four-terminal method. The thermal expansion coefficient was measured in the temperature range of 30° C. to 500° C. with a commercially available measuring device.

In addition, for the wires of Sample Nos. 1 and 100, a conducting current necessary to reach a Curie temperature was determined by a calculation. The results are shown in Table II. The calculation was performed as follows.

When a surface area of a wire is represented by S, a heat transfer coefficient of the wire per a unit area and a unit time is represented by ν, a resistivity of the wire is represented by R, a value of conducting current is represented by i, room temperature is represented by θ₀, and a temperature of the wire is represented by θ, a relational formula (θ−θ₀)=R×i²/(S×ν) is established. The value of conducting current i was determined by substituting room temperature θ₀=20° C., temperature θ of wire=Curie temperature shown in Table II, resistivity R=ρ×1/(ρ²), surface area S=0.11 m², and heat transfer coefficient ν=10 W/m²/K for this relational formula. Regarding the resistivity R, ρ represents the specific resistance shown in Table II, I represents a length of the wire of 60 mm, and r represents a radius of the wire of 0.3 mm.

TABLE II

| | | | Thermal expansion | |
|---|---|---|---|---|
| | Curie | Specific | coefficient | Current value |
| Sample | temperature | resistance | (30° C. to 500° C.) | that can be |
| No. | (° C.) | (μΩ · cm) | (ppm/K) | used (A) |
| 1 | 980 | 8.45 | 9.0 | 25 |
| 100 | 520 | 35.8 | 10.3 | 8.6 |

As shown in Table II, it is found that the wire of Sample No. I composed of an iron-group alloy which is a ternary alloy of Co, Fe, and Ni having a particular composition and which has a cubic crystal structure has a high Curie temperature (900° C. or higher) and a low resistance (a specific resistance of 9 μΩ·cm or less at room temperature in this sample). It is also found that since Sample No. 1 has a high Curie temperature, the current that can be supplied until the temperature of the wire reaches the Curie temperature is high. Accordingly, even in the case where a large current is allowed to flow to the wire of Sample No. 1, the temperature of the wire does not easily reach the Curie temperature. In addition, since the wire of Sample No. 1 has a low specific resistance, the temperature of the wire does not easily increase. Thus, degradation of the magnetic property and the electric property due to an increase in the temperature is suppressed. It is expected that the wire of Sample No. 1 can be suitably used in a large-current application.

Furthermore, the wire of Sample No. I can be satisfactorily subjected to wiredrawing to form a thin wire having a diameter of 1 mm or less, even though the wire contains a large amount of Co. Thus, it is found that the wire of Sample No. 1 also has good workability. The wire of Sample No. 1 was cut to have a particular length, and press working was performed on an end side of the wire. In order to simulate a contact point portion of a reed for a reed switch, the wire was formed so as to have a flat plate shape hire. After the forming, the end side of the wire was visually observed. Cracks etc. were not formed at an edge of the wire. This result also shows that the wire of Sample No. 1 has good workability.

In addition, the wire of Sample No. 1 has a small thermal expansion coefficient in a wide temperature range of 30° C. to 500° C. Thus, even if a large current is allowed to flow and the temperature of the wire increases, the amount of thermal expansion and contraction is small.

As described above, a wire composed of an iron-group alloy which is a ternary alloy of Co, Fe, and Ni having a particular composition and which has a cubic crystal structure has a high Curie temperature, a small specific resistance, and a good plastic working property. Accordingly, it is expected that the wire can be suitably used as a material of reeds for a reed switch and a reed switch including the reeds. In addition, even in the case where a large current is allowed to flow to this wire, the temperature of the wire does not easily increase. Thus, degradation of properties due to an increase in the temperature, defects of bonding with a glass tube for a reed switch, etc. do not easily occur. It is expected that the wire can be suitably used as a material of a reed switch for a large-current application. It is also expected that this wire can be suitably used as a material of a reed switch for a low-current application. Furthermore, even if the temperature of the wire becomes high, the amount of thermal expansion and contraction is small. Accordingly, the adhesion state with a glass tube for a reed switch can also be easily maintained. It is expected that the wire can contribute to the realization of a long lifetime of a reed switch.

The present invention is not limited to the embodiments described above. Various modifications can be appropriately made without departing from the gist of the present invention. For example, the composition of the iron-group alloy, the wire diameter, etc. may be changed.

### INDUSTRIAL APPLICABILITY

The wire for a reed switch of the present invention can be suitably used as a material of a reed included in a reed switch. The reed for a reed switch of the present invention can be suitably used as a component of a reed switch. The reed switch of the present invention can be suitably used in a switching component, a sensor component, and the like in electric/electronic devices in combination with a permanent magnet or an electric magnet. Specific examples of the switching component and the sensor component include on-vehicle components, such as a reed relay, a speed sensor, and a shock sensor; components of household electric appliance, such as a reed relay, a crime prevention sensor, and a gas flow rate sensor; and components of portable electric devices, such as a proximity sensor of a cellular phone or the like.

1. A wire for a reed switch, the wire being used as a material of a reed included in a reed switch, comprising:
an iron-group alloy containing, by percent by mass,
1% or more and 10% or less of Fe,
10% or more and 35% or less of Ni, and
the balance being Co and impurities,
wherein the iron-group alloy has a cubic crystal structure, and the wire has a Curie temperature of 900° C. or higher and a wire diameter of 1 mm or less.

2. The wire for a reed switch according to claim 1,
wherein the wire is composed of an iron-group alloy containing, by percent by mass,
3% or more and 5% or less of Fe,
20% or more and 30% or less of Ni, and
the balance being Co and impurities.

3. The wire for a reed switch according to claim 1, wherein a specific resistance at room temperature is 15 μΩ·cm or less.

4. A reed for a reed switch, the reed being produced from the wire for a reed switch according to claim 1 and comprising, on an end side thereof, a contact point portion formed by plastic working.

5. A reed switch comprising a cylindrical glass tube and a plurality of reeds fixed to the glass tube in a state where an end side including a contact point portion of each of the reeds is inserted in the glass tube,
wherein the reeds are each the reed for a reed switch according to claim 4.
